(19) United States
(12) Patent Application Publication
(10) Pub. No.: US 2018/0114374 A1
(43) Pub. Date: Apr. 26, 2018

(54) Method for Determining Fee For Sending a Mailing

(71) Applicant: Deutsche Post AG, Bonn (DE)

(72) Inventor: Matthias Rakow, Teltow (DE)

(21) Appl. No.: 15/793,428

(22) Filed: Oct. 25, 2017

(30) Foreign Application Priority Data
Oct. 26, 2016 (DE) 10 2016 120 406.4

(51) Int. Cl. G07B 17/00; G01G 19/414

(52) U.S. Cl. CPC G07B 17/00362; G07B 2017/00685; G07B 2017/00701; G01G 19/4148

(57) ABSTRACT

Example aspects of the present disclosure relate to a method for determining a fee for sending a mailing, comprising the steps of: a) determining the weight and/or the volume of the mailing, b) selecting a three-dimensional body corresponding to the weight and/or the volume of the mailing, c) projecting the three-dimensional body onto the mailing, d) checking whether the three-dimensional body can enclose the mailing, e) if the three-dimensional body cannot enclose the mailing, selecting a larger three-dimensional body and repeating steps c) and d), f) if the three-dimensional body can enclose the mailing, determining the fee for sending the mailing in dependence on the determined weight and/or the volume and the selected three-dimensional body.

### PRIORITY STATEMENT

The present application claims the benefit of priority under 35 U.S.C. § 119 to German Application No. 10 2016 120 406.4, filed on Oct. 26, 2016.

### FIELD

Example aspects of the present disclosure relate to a method for determining a fee for sending a mailing, comprising the step of determining the weight and/or the volume of the mailing.

### BACKGROUND

Despite constantly increasing automation, the determination of a fee for sending a mailing, such as for example a parcel or the like, is frequently still a manual process which takes up a lot of time of an employee accepting the mailing and thus generates extraordinary costs. When accepting a parcel in a branch of a logistics service provider, it is a routine necessity for the employee accepting the parcel to weigh the parcel and to measure the dimensions of the parcel manually using a measuring tape, a pocket rule or a fixed template. The dimensions and the specific weight are then compared, likewise manually, by the employee to dimension classes for mailings to determine an appropriate fee for sending the mailing. This method is often susceptible to errors and takes an unnecessarily long amount of time.

Methods for automatically determining the dimensions of a mailing, as are known from the prior art, to date have been technically complicated and require corresponding calibration, which also makes the method costly. For this reason, such methods comprising for example optical measurement of the mailing are not used in the branches of the logistics service providers.

### SUMMARY

Aspects and advantages of embodiments of the present disclosure will be set forth in part in the following description, or may be learned from the description, or may be learned through practice of the embodiments.

One example aspect of the present disclosure is directed to a method for determining a fee for sending a mailing. The method includes a) determining the weight or the volume of the mailing. The method includes b) selecting a three-dimensional body corresponding to the weight or the volume of the mailing. The method includes c) projecting the three-dimensional body onto the mailing. The method includes d) checking whether the three-dimensional body can enclose the mailing. The method includes e) when the three-dimensional body cannot enclose the mailing, selecting a larger three-dimensional body and repeating c) and d). The method includes f) when the three-dimensional body can enclose the mailing, determining the fee for sending the mailing in dependence on the weight or the volume and the selected three-dimensional body.

### BRIEF DESCRIPTION OF THE DRAWINGS

FIG. 1 shows a schematic illustration for performing a proposed method according to example embodiments of the present disclosure,

FIG. 2 shows a schematic illustration for performing the proposed method according to example embodiments of the present disclosure, and

FIG. 3 shows a schematic illustration for performing the proposed method according to example embodiments of the present disclosure.

### DETAILED DESCRIPTION

Example aspects of the present disclosure specify an improved method for determining a fee for sending a mailing, with which the fee for the mailing is determinable in a particularly error-proof and simple manner.

One example aspect is directed to a method for determining a fee for sending a mailing, comprising:
a) determining the weight and/or the volume of the mailing,
b) selecting a three-dimensional body corresponding to the weight and/or the volume of the mailing,
c) projecting the three-dimensional body onto the mailing,
d) checking whether the three-dimensional body can enclose the mailing,
e) if the three-dimensional body cannot enclose the mailing, selecting a larger three-dimensional body and repeating steps c) and d),
f) if the three-dimensional body can enclose the mailing, determining the fee for sending the mailing in dependence on the determined weight and/or the volume and the selected three-dimensional body.

In this way, in some embodiments, a measurement of the dimensions of the mailing for determining the fee no longer needs to be performed manually by an employee for example in a branch of a logistics service provider, but the fee can be determined in automated fashion by the proposed method. Rather than manually measuring the mailing, as is known from the prior art and still practiced regularly today, the three-dimensional body provides a kind of virtual template. In the simplest form of the proposed method, the employee can visually check whether the three-dimensional body encompasses the mailing in order to subsequently determine, on the basis of the dimensions of the three-dimensional body and of the weight and/or of the volume of the mailing, the fee that is appropriate for the mailing. In this way, the fee can be obtained in a more error-proof and simple manner.

By selecting the three-dimensional body corresponding to the weight and/or the volume of the mailing, a type of preselection of the three-dimensional body, for example from a defined plurality of possible dimensions and/or classes of three-dimensional bodies to which in each case a maximum weight and/or volume is assigned, can be performed. The preselection can be changed iteratively by way of step e) until the three-dimensional body can enclose the mailing. When accepting a mailing in the branch of the logistics service provider, for example a postal operator, the mailing is often placed on a table of a shop counter and the weight of the mailing is determined by weighing it. The selected three-dimensional body in step c) can be projected onto the mailing that has been placed onto the table.

In the next step d), a check is carried out as to whether the three-dimensional body can preferably completely enclose, encompass or locate the mailing, e.g., the mailing can be disposed preferably completely within the three-dimensional body. That means that a check is carried out in particular as to whether the dimensions of the three-dimensional body exceed the dimensions of the mailing at preferably every location or are at least of equal size, for example whether in the case of a rectangular mailing and a rectangular three-dimensional body the width, height and depth of the body are at least of equal size as the mailing. Checking can comprise the employee moving the mailing, which has been placed on the table, over the table in the direction of the projection until the three-dimensional body encloses the mailing or until the mailing is located within the three-dimensional body.

If this is not the case, e.g., if in accordance with step e) the three-dimensional body cannot enclose the mailing, a three-dimensional body which is larger as compared to the previous three-dimensional body can be selected, and steps c) and d) are repeated, maybe several times. Selecting the larger three-dimensional body for its part can be done manually by the employee or in automated fashion by a computer. When the three-dimensional body can enclose the mailing preferably completely, the fee for sending the mailing is determined in step f) in dependence on the determined weight and/or the volume and the selected three-dimensional body, for example manually by the employee by reading a postage table or alternatively in automated fashion by the computer based on postage calculations. Step f) can comprise confirming the selected three-dimensional body in order to determine the fee only afterwards. The fee, also referred to as postage, is in particular a monetary amount for sending the mailing from the sender to the receiver and is additionally frequently dependent on the location of the sender and/or of the receiver. The steps of the method, in some embodiments, can be performed at least partially and with particular preference entirely by the computer as part of a computer-implemented method.

In some embodiments, projecting the three-dimensional body comprises optically showing edges and/or dimensions and/or a hologram of the three-dimensional body and/or is performed by way of a laser. When the mailing has been placed on the table of a branch, the edges of the three-dimensional body or the hologram are preferably optically shown on the table. The hologram represents a type of virtual template, that is to say a virtual mailing, as it were, that has been placed on the table. A mark can be provided on the table on which the mailing is to be placed and which is enclosed centrally by the three-dimensional body, in particular by one side of the three-dimensional body, or the hologram. The employee can thereby ascertain in a particularly simple fashion whether the mailing can be enclosed by the three-dimensional body.

In principle there are many possibilities for determining the weight of the mailing. In some embodiments, determining the weight comprises weighing the mailing and/or is performed using scales. The scales are preferably integrated in the table, connected to the computer and/or arranged at the location at which the three-dimensional body is projected onto the mailing.

In some embodiments, step a) comprises determining a weight class corresponding to the weight and/or a volume class corresponding to the volume, and step b) comprises selecting the three-dimensional body corresponding to the weight class and/or the volume class of the mailing. The fee for a mailing is frequently defined in dependence on a weight class of, for example, 1 to 2 kg, wherein maximum dimensions of the mailing are fixed for a respective weight class. For example, if the weight is 1.5 kg, and the maximum dimensions for the weight class 1 to 2 kg are 60 cm×30 cm×15 cm, then the projected three-dimensional body would have the dimensions of 60 cm×30 cm×15 cm. A rectangular mailing having the dimensions of 60 cm×30 cm×15 cm would be entirely encompassed by the three-dimensional body, which would no longer be the case if the mailing had dimensions of 60 cm×30 cm×20 cm. The next greater weight class could comprise 2 to 5 kg and the maximum dimensions of 120 cm×30 cm×20 cm. The volume class can be determined analogously and can comprise, for example, 0.1 to 0.25, 0.25 to 0.5 or 0.5 to 1 m³.

In addition, an alternative or additional step f″) can be provided, if the three-dimensional body can enclose the mailing. Step f″) can include checking whether a smaller weight class and/or volume class is available for the same three-dimensional body and, if that is the case, determining the fee for sending the mailing in dependence on the selected smaller weight class and/or volume class and the selected three-dimensional body. The method can include comprises the steps e′), selecting the three-dimensional body of the next greater weight class and/or volume class and repeating steps c) and d) if the three-dimensional body cannot enclose the mailing, and f′), determining the fee for sending the mailing in dependence on the determined weight class and/or volume class and the selected three-dimensional body if the three-dimensional body can enclose the mailing. In the case of the volume, it is also possible, if the three-dimensional body can enclose the mailing, to check whether a next smaller volume class can enclose the mailing, which would be selected if that were the case. The terms next smaller or next greater refer, for example, to predefined weight categories or classes and/or volume categories or classes.

In principle, the method can be used for mailings of different types. In accordance with an example embodiment, a rectangular mailing is provided which comprises a reference corner and a diagonal corner that is situated diagonally opposite the reference corner, and the method comprises the steps of:
a′) arranging the reference corner of the mailing at a reference point,
a″) scanning the mailing at the diagonal corner using a camera and/or a hand-held scanner,
a′″) determining the dimensions of the mailing by triangulating the scanned mailing and/or by way of contrast analysis of the scanned mailing,
b′) selecting the three-dimensional body corresponding to the weight and/or the volume and the dimensions of the mailing.

Mailing here refers to any transportable item, for example a parcel, package, letter or the like. Parcels and packages frequently have a rectangular shape. For particularly simple determination of the three-dimensional body, it is possible for example to provide a reference point in the form of an edge or a guide on the table in the branch. The mailing is preferably arranged at this reference point such that it is in contact with the reference corner thereof. Using a hand-held scanner that is already available in the branch and is otherwise used for scanning 2D barcodes of mailings, the mailing can be scanned at the diagonal corner in what is known as camera mode. During scanning at the diagonal corner, the reference corner is covered by the mailing and the hand-held scanner captures, in addition to the diagonal corner, at least the three edges extending from the diagonal corner and the three associated sides of the rectangular mailing. By subsequent triangulation and/or a contrast analysis it is possible, in a particularly simple manner, to determine the dimensions of the scanned mailing and, corresponding thereto, the three-dimensional body, in particular in automated fashion by way of the computer. It is likewise possible to use a camera, for example a video camera, possibly using image recognition software, to determine the dimensions of the mailing. Ultimately, the proposed steps make possible particularly simple determination of the smallest possible three-dimensional body using a hand-held scanner that is already available in the branch.

In some embodiments, the method comprises the steps of:
e′) reading a 2D barcode of the mailing, and
f′) determining the fee for sending the mailing in dependence on the determined weight and/or the volume, the selected three-dimensional body and the read 2D barcode.

The 2D barcode can have lines and/or dots of different widths and gaps therebetween at as high a contrast as possible and is configured for example in the form of a matrix code and in particular of a QR code such that it is optoelectronically readable, preferably likewise by way of the hand-held scanner. The 2D barcode with further preference contains digital information relating to the sender, the receiver and/or other information pertaining to the mailing, such as for example express delivery, preliminary information for the fee or the like. It is possible with this configuration to determine the fee for sending the mailing not only in dependence on the weight and/or the volume and the dimensions of the mailing, but also on the distance between sender and receiver.

In some embodiments, the method comprises the steps a′″), determining a three-dimensional model of the mailing, and b′″), selecting the three-dimensional body corresponding to the weight and/or the volume and the three-dimensional model of the mailing by way of a computer. The three-dimensional model of the mailing can be obtained using a camera that is fixed to the table and/or by way of a hand-held scanner mounted in the branch and/or by way of the computer, possibly using image recognition software. Selecting the three-dimensional body is preferably performed such that the computer selects in automated fashion the smallest possible three-dimensional body, in particular of the weight class corresponding to the weight and/or volume class corresponding to the volume, that completely encloses the three-dimensional model. The three-dimensional model can be realized by a surface analysis of the mailing, in which exact scanning of the contours of the mailing or the clear dimensions of the mailing in all three spatial coordinates is performed. In some embodiments, the automatic selection of the three-dimensional body can be corrected manually by an employee.

In some embodiments, the method comprises the following steps:
c′) projecting the three-dimensional body onto the three-dimensional model of the mailing by way of a computer,
c″) preferably representing the three-dimensional body and the three-dimensional model of the mailing on a computer screen of the computer, and
d′) checking by way of the computer whether the three-dimensional body can enclose the three-dimensional model of the mailing.

In this embodiment, projecting the three-dimensional body onto the three-dimensional model can also be done on the computer screen, i.e. alternatively or possibly additionally to the projection of the three-dimensional body onto the mailing that has been placed onto the table in the branch. In an alternative case, the steps b′″), c′) and/or d′) can substitute the steps b), c) and/or d). The relevant embodiment in any case makes possible completely automated determination of the fee and, additionally, a particularly simple possibility for a plausibility check on the computer screen, a possible change of the three-dimensional body into a next larger or smaller three-dimensional body, and/or confirming the selected three-dimensional body on the computer screen.

In some embodiments, provision can be made for the three-dimensional body to be in the form of a cuboid, a cylinder, a sphere, a cube, a pyramid or a prism and/or to comprise a virtual template. Provision can be made for the computer to automatically select a cuboid, cylinder, sphere etc. as the three-dimensional body, in particular based on the obtained three-dimensional model of the mailing. It can also be possible for the operator to perform such a selection manually based on the external shape of the mailing or on his or her experience in order to determine an encompassing three-dimensional body, which is as small as possible, as what is known as a dimension class inside which the mailing can be located in its entirety. The selected cuboid, cylinder, sphere etc. can be projected onto the mailing in the form of a three-dimensional body.

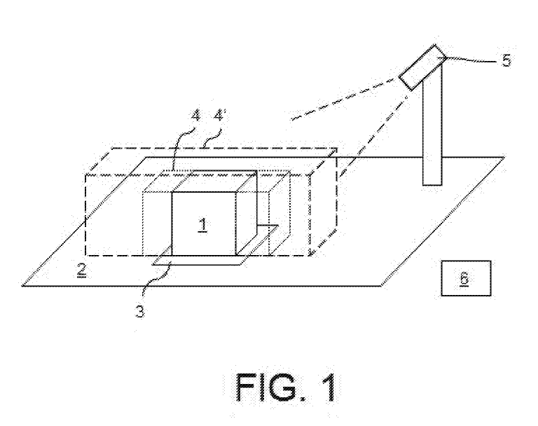

FIG. 1 shows a schematic illustration of an example embodiment for performing the proposed method for determining a fee for sending a mailing 1 in a branch of a logistics service provider. The mailing 1 is placed on a table 2 in the branch on scales 3 that are located in the table 2, such that it is possible by way of the scales 3 to determine the weight of the mailing 1 in a first step a). The mailing 1 constitutes a parcel in the form of an equilateral cube having 12 edges of equal length. Alternatively or additionally to the weight, it is also possible to determine the volume of the mailing 1, for example using a camera or devices which will be described below. In this respect, the following statements apply analogously to the volume of the mailing 1, even if only the weight of the mailing 1 is mentioned.

In a subsequent, second step b), a three-dimensional body 4 corresponding to the weight of the mailing 1 is selected, and, in step c), projected onto the mailing 1, shown in FIG. 1 by dashed lines. Next, a check is performed in step d) as to whether the three-dimensional body 4 can completely enclose the mailing 1, i.e. the mailing 1 does not at any location project beyond the three-dimensional body 4.

In the case shown, the three-dimensional body 4 has exactly the same height and depth as the mailing 1, but exceeds its width, such that the mailing 1 is enclosed completely by the three-dimensional body 4. If, however, the three-dimensional body 4 cannot enclose the mailing 1, then a three-dimensional body 4′ which is greater in terms of its dimensions than the represented three-dimensional body 4 is selected in step e), with body 4′ being illustrated by way of example by dashed lines having longer dashes. The steps c) and d) are repeated iteratively until the three-dimensional body 4 can completely enclose the mailing 1. When the three-dimensional body 4 encloses the mailing 1 completely, the fee for sending the mailing 1 is determined in dependence on the determined weight and the selected three-dimensional body 4.

The three-dimensional body 4 is projected as described previously by optically showing the edges of the three-dimensional body 4, which are represented by a laser 5, which is attached to the table 2, in the form of a hologram in the region of the scales 3 and are illustrated by way of lines 4 that are made up of small dashes. By pivoting the laser 5 or displacing the mailing 1 on the table 2 by way of an employee in the branch, it is possible to align the hologram or the mailing 1 on the table 2 such that the mailing 1 is ideally located completely, as completely as possible or at least centrally within the hologram as a three-dimensional body 4.

A computer 6, illustrated schematically, which is connected to the scales 3 and to the laser 5, determines, on the basis of the determined weight, a weight class of the mailing 1 corresponding to the weight in a step b″). The computer 6 is provided with a database, or the computer 6 compares the weight against a database provided in a network, and ascertains the corresponding weight class and the maximum dimensions of the mailing 1 corresponding to the weight class. The maximum dimensions are then projected using the laser 5 onto the table 2 in the form of edges of the three-dimensional body 4.

If the employee in the branch sees that the three-dimensional body 4 is larger than the mailing 1, the employee can select a three-dimensional body that has smaller dimensions than the represented three-dimensional body 4 by selecting a smaller weight class and can possibly repeatedly perform the steps c) and d). The selection of the smaller or larger three-dimensional body 4′ can be effected by way of buttons (not illustrated) or a mouse or keyboard connected to the computer by selecting a smaller or greater weight class compared to the previous weight class.

In a step e′), for example, the three-dimensional body 4′ of the next greater weight class that has a greater volume and greater dimensions than the three-dimensional body 4 of the previous weight class is selected, and then the steps c) and d) are repeated. Analogously, in a step f′), the fee for sending the mailing 1 is determined in dependence on the determined weight class and the selected three-dimensional body 4, if the three-dimensional body 4 completely encloses the mailing 1.

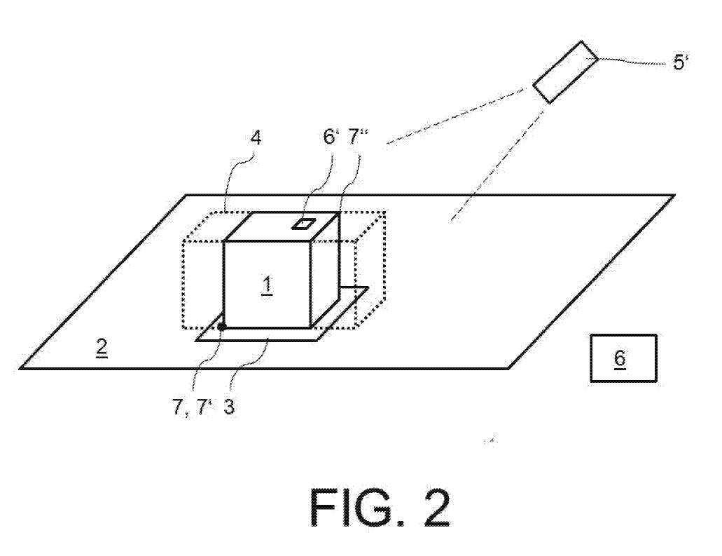

FIG. 2 shows a schematic illustration of another example embodiment for performing the proposed method for determining the fee for sending the mailing 1. In contrast to FIG. 1, rather than using a laser 5 that is fixedly connected to the table, a hand-held scanner 5′ is used which is operated in what is known as camera mode. Branches of a logistics service provider are frequently equipped with hand-held scanners 5′ with which a 2D barcode 6′ that is provided on the mailing 1 can be read in a step e). The 2D barcode 6′ is, for example, in the form of a QR code and can contain information relating to a sender and receiver of the mailing 1, to the content of the mailing 1 or to other information relating to the mailing 1 or can already contain the fee for the mailing.

Provided on the table 2 in the region of the scales 3 is a reference point 7, at which the mailing 1 is arranged in touching contact with a reference corner 7′ in a step a′). The mailing 1 is then scanned at a diagonal corner 7″ of the mailing 1 that is situated diagonally opposite the reference corner 7′ by the employee using the hand-held scanner 5′, or alternatively using a camera that is fixedly installed on the table, in a step a″). As can be seen in FIG. 2, the hand-held scanner 5′ is to this end held against the mailing 1 such that the diagonal corner 7″ and the edges of the mailing 1 that extend therefrom can be scanned, while the reference corner 7′ is covered by the mailing.

By triangulating the scanned mailing 1 and/or by way of contrast analysis of the scanned mailing 1, it is possible in a step a′″) to determine the dimensions of the mailing 1 using the computer 6. The computer 6 is again used to determine, in a subsequent step, the three-dimensional body 4 that corresponds to the weight and the dimensions of the mailing 1, so as to determine the smallest possible three-dimensional body 4. In a subsequent step f′), the fee for sending the mailing 1 can be determined in dependence on the determined weight, the selected three-dimensional body 4 and the read 2D barcode 6′.

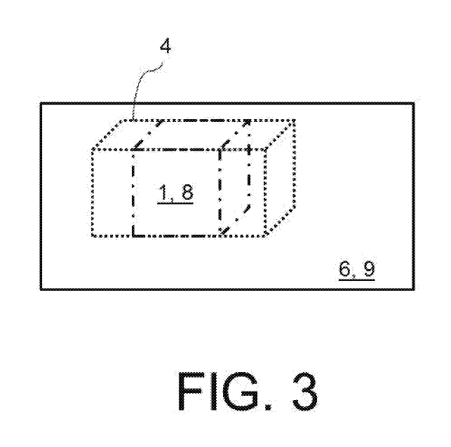

In accordance with an example embodiment, first a three-dimensional model 8 of the mailing 1 is determined in a step a′″), illustrated by a dashed line in FIG. 3. The three-dimensional model 8 of the mailing 1 is produced, for example, as described above and shown in FIG. 2, using the hand-held scanner 5′ or using a camera by way of three-dimensional scanning of the mailing 1. The camera can be realized by way of a scanner in the form of a laser scanner, with which exact imaging of the mailing 1 in all three spatial coordinates is achieved in the form of a three-dimensional model 8. In a subsequent step b″), the three-dimensional body 4 is selected in automated fashion by a computer 6 corresponding to the weight and the three-dimensional model 8 of the mailing 1. The computer 6 selects, corresponding to the weight class, the smallest possible three-dimensional body 4 that surrounds the three-dimensional model 8.

To allow the employee in the branch to check the selection made by the computer, the computer 6 represents on its computer screen 9 in a step c′) or c″) the projection of the three-dimensional body 4 onto the three-dimensional model 8 of the mailing 1, as is shown in FIG. 3. It is likewise possible for the computer 6 to check in automated fashion and thus independently whether the three-dimensional body 4 can enclose the three-dimensional model 8 of the mailing, or if a smaller or larger three-dimensional body 4′ must be selected. The selection of the three-dimensional body 4 can be changed by the employee using buttons (not illustrated) or using the mouse or keyboard connected to the computer. The employee can also change a shape of the three-dimensional body 4, for example a cuboid, a cylinder, a sphere, a pyramid or a prism, or select a virtual template of any desired form.

The described embodiments are merely examples that can be modified and/or supplemented in many ways within the framework of the claims. Each feature that was described for a specific exemplary embodiment can be used on its own or in combination with other features in any desired other embodiment. Every feature that was described for an exemplary embodiment of a specific category can also be used correspondingly in an exemplary embodiment of a different category.

1-19. (canceled)

20. A method for determining a fee for sending a mailing, comprising:
a) determining the weight or the volume of the mailing,
b) selecting a three-dimensional body corresponding to the weight or the volume of the mailing,
c) projecting the three-dimensional body onto the mailing,
d) checking whether the three-dimensional body can enclose the mailing,
e) when the three-dimensional body cannot enclose the mailing, selecting a larger three-dimensional body and repeating c) and d),
f) when the three-dimensional body can enclose the mailing, determining the fee for sending the mailing in dependence on the weight or the volume and the selected three-dimensional body.

21. The method of claim 20, wherein determining the weight or the volume of the mailing comprises determining the weight and the volume of the mailing, wherein the three-dimensional body is selected corresponding to the weight and the volume of the mailing, wherein the fee for sending the mailing is determined in dependence on the weight and the volume.

22. The method according to claim 20, wherein projecting the three-dimensional body comprises optically showing edges of the three-dimensional body or comprises optically showing a hologram of the three-dimensional body

23. The method according to claim 20, wherein projecting the three-dimensional body is performed by way of a laser.

24. The method according claim 20, wherein determining the weight or the volume of the mailing comprises determining the weight, and determining the weight comprises weighing the mailing.

25. The method according to claim 20, wherein the mailing comprises a rectangular mailing comprising a reference corner and a diagonal corner that is situated diagonally opposite the reference corner, the method comprising:
arranging the reference corner of the mailing at a reference point,
scanning the mailing at the diagonal corner using a camera or a hand-held scanner,
determining the dimensions of the mailing by triangulating the scanned mailing or by way of contrast analysis of the scanned mailing,
selecting the three-dimensional body corresponding to the weight or the volume and the dimensions of the mailing.

26. The method according to claim 20, further comprising:
reading a 2D barcode of the mailing, and
determining the fee for sending the mailing in dependence on the determined weight or the volume, the selected three-dimensional body and the 2D barcode.

27. The method according to claim 20, further comprising
selecting the three-dimensional body corresponding to a weight class based on the weight of the mailing or a volume class based on the volume of the mailing,
when the three-dimensional body cannot enclose the mailing, selecting the three-dimensional body of the next greater weight class or the next greater volume class and repeating c) and d),
when the three-dimensional body can enclose the mailing, determining the fee for sending the mailing in dependence on the determined weight class or the next greater volume class and the selected three-dimensional body.

28. The method according to claim 20, further comprising:
determining a three-dimensional model of the mailing, and
selecting the three-dimensional body corresponding to the weight or the volume and the three-dimensional model of the mailing by way of a computer.

29. The method according method to claim 28, comprising:
projecting the three-dimensional body onto the three-dimensional model of the mailing by way of a computer, and
checking using the computer whether the three-dimensional body can enclose the three-dimensional model of the mailing.

30. The method according to claim 29, comprising:
representing the three-dimensional body and the three-dimensional model of the mailing on a computer screen of the computer

31. The method according to claim 20, wherein the three-dimensional body is in the form of a cuboid, a cylinder, a sphere, a cube, a pyramid or a prism, or comprises a virtual template.

32. The method according to claim 25, comprising:
selecting the three-dimensional body corresponding to a weight class based on the weight of the mailing or a volume class based on the volume of the mailing,
when the three-dimensional body cannot enclose the mailing, selecting the three-dimensional body of the next greater weight class and/or the next greater volume class and repeating c) and d),
when the three-dimensional body can enclose the mailing, determining the fee for sending the mailing in dependence on the determined weight class or the next greater volume class and the selected three-dimensional body.

33. A method for determining a fee for sending a mailing, comprising the steps of:
a) determining the weight or the volume of the mailing by determining a three-dimensional model of the mailing,
b) selecting, using a computer, a three-dimensional body corresponding to the weight or the volume of the mailing,
c) projecting, using the computer, the three-dimensional body onto the mailing,
d) checking, using the computer, whether the three-dimensional body can enclose the mailing,
e) when the three-dimensional body cannot enclose the mailing, selecting a larger three-dimensional body and repeating c) and d),
f) when the three-dimensional body can enclose the mailing, determining the fee for sending the mailing in dependence on the determined weight or the volume and the selected three-dimensional body, wherein

34. The method according to claim 33, wherein the mailing comprises a rectangular mailing comprising a reference corner and a diagonal corner that is situated diagonally opposite the reference corner, the method comprising:
arranging the reference corner of the mailing at a reference point,
scanning the mailing at the diagonal corner using a camera or a hand-held scanner,
determining the dimensions of the mailing by triangulating the scanned mailing or by way of contrast analysis of the scanned mailing,
selecting the three-dimensional body corresponding to the weight or the volume and the dimensions of the mailing.

35. A method according to claim 34, comprising:
selecting the three-dimensional body corresponding to a weight class based on the weight of the mailing or a volume class based on the volume of the mailing,
when the three-dimensional body cannot enclose the mailing, selecting the three-dimensional body of the next greater weight class or the next greater volume class and repeating c) and d),
when the three-dimensional body can enclose the mailing, determining the fee for sending the mailing in dependence on the determined weight class or the next greater volume class and the selected three-dimensional body.

36. A method for determining a fee for sending a mailing, comprising the steps of:
a) determining the weight or the volume of the mailing,
b) selecting a three-dimensional body corresponding to the weight or the volume of the mailing,
c) projecting the three-dimensional body onto the mailing,
d) checking whether the three-dimensional body can enclose the mailing,
e) when the three-dimensional body cannot enclose the mailing, selecting a larger three-dimensional body and repeating c) and d),
f) when the three-dimensional body can enclose the mailing, determining the fee for sending the mailing in dependence on the determined weight and/or the volume and the selected three-dimensional body,
wherein projecting the three-dimensional body comprises optically showing edges or a hologram of the three-dimensional body or projecting the three-dimensional body by way of a laser.

37. The method according to claim 36, wherein the mailing comprises a rectangular mailing comprising a reference corner and a diagonal corner that is situated diagonally opposite the reference corner, the method comprising:
arranging the reference corner of the mailing at a reference point,
scanning the mailing at the diagonal corner using a camera or a hand-held scanner,
determining the dimensions of the mailing by triangulating the scanned mailing and/or by way of contrast analysis of the scanned mailing,
selecting the three-dimensional body corresponding to the weight or the volume and the dimensions of the mailing.

38. The method according to claim 37, comprising:
selecting the three-dimensional body corresponding to a weight class based on the weight of the mailing or a volume class based on the volume of the mailing,
when the three-dimensional body cannot enclose the mailing, selecting the three-dimensional body of the next greater weight class or the next greater volume class and repeating c) and d),
when the three-dimensional body can enclose the mailing, determining the fee for sending the mailing in dependence on the determined weight class or the next greater volume class and the selected three-dimensional body.
